(19) United States
(12) Patent Application Publication
(10) Pub. No.: US 2012/0158999 A1
(43) Pub. Date: Jun. 21, 2012

(54) METHOD AND APPARATUS FOR TERMINAL CAPABILITY INFORMATION BASED INCOMPATIBLE MEDIA CONTENTS TRANSFORMATION

(75) Inventor: Yoon Sik YOO, Daejeon (KR)

(73) Assignee: ELECTRONICS AND TELECOMMUNICATIONS RESEARCH INSTITUTE, Daejeon (KR)

(21) Appl. No.: 13/325,870

(22) Filed: Dec. 14, 2011

(30) Foreign Application Priority Data
Dec. 16, 2010 (KR) 10-2010-0129521

(51) Int. Cl. G06F 15/16

(52) U.S. Cl. 709/246

(57) ABSTRACT

Provided are an apparatus and a method for incompatible media contents transformation based on terminal capability information. The apparatus for incompatible media contents transformation based on terminal capability information includes a service distributor checking the capability information of a connected user terminal and outputting transformation information to request based on the capability information, and a contents transformation unit receiving the transform information, being supplied with the incompatible media contents based on the received transform information, transforming the supplied incompatible media contents into the media contents compatible with the user terminal, and providing the compatible media contents to the service distributor. The apparatus and method may effectively provide the transformed media contents to heterogeneous terminals and may reduce additional loss by reducing the time and cost such as minimizing a duplicate transformation processing load of the contents transcoder.

### CROSS-REFERENCE TO RELATED APPLICATIONS

This application claims priority to and the benefit of Korean Patent Application NO. 10-2010-0129521 filed in the Korean Intellectual Property Office on Dec. 16, 2010, the entire contents of which are incorporated herein by reference.

### TECHNICAL FIELD

The present invention relates to a method and an apparatus for incompatible media contents transformation based on terminal capability information. More particularly, the present invention relates to the method and the apparatus for incompatible media contents collaboration-transformation based on terminal capability information determining the capability information of a heterogeneous terminal, transforming the incompatible media contents for the terminal into the media contents capable of accommodating in the terminal and transmitting the accommodated media contents to the terminal.

### BACKGROUND

The media contents may generally include video data and audio data. Movies, music videos and dramas and the like are examples of storage media, and real-time monitoring network cameras and real-time VoD streaming, etc., are representative examples of media contents as real-time streaming media.

According to a development of recent data compression technologies and the terminal manufacturing technologies, various terminals mounted with various codecs are being launched. There are many cases where types of codecs mounted to the terminals on markets are different from each other. In particular, the sizes of a screen and a terminal, a data processing speed, a memory capacity, the number of communication network device, etc. are reduced, such that a manufacturing cost are lowered. Therefore, the codecs following a nature of each terminal or a policy of a manufacturing company are mounted on the portable terminal putting the emphasis on portability. The representative example of the portable terminal includes a portable phone, a PMP, a MP3 player, a PSP, a notebook, a UMPC, etc.

With the development of a communication network and a broadcasting network, utilization in the portable terminal has further increased and the types of portable terminals have variously changed. Accordingly, even though the media contents have the same content, when the types of the terminals are different from each other, it is often impossible to reproduce the media contents. In this case, a user can reproduce and enjoy the media contents after transforming the codecs of the media contents according to the codecs supported by own terminal.

In the related art, when using the storage media, the user connects to a contents providing system such as a website providing the media contents using a PC, such that the user downloads the required media contents and is provided with the media contents only transformed into the codecs supported by the terminal.

The user transforms the downloaded media contents into a file format capable of being decoded with the codecs supported by the portable terminal such as the user's portable phone. Further, when using a real time streaming media, the user selectively receives the media contents only transformed with the codecs supported by a user terminal and may be provided with the streaming service.

Therefore, the user using various types of terminal wastes unnecessary time and effort due to a number of file format transformation using each of the file format transformation programs provided by various companies when using the storage medium, and is inconvenient due to connecting to a website that only provides the format supported by the terminal or a format transformation to transfer streaming whenever the terminal is connected when using the real time streaming media.

As such, when transforming the real-time format with the terminal and streaming the transformed real-time format, although the same type of terminals are connected, format transformation is performed and transmitted. Therefore, the server transforming and transmitting the format has a limit due to load.

### SUMMARY

The present invention had been made in an effect to provide a method and an apparatus for incompatible media contents transformation based on terminal capability information capable of checking the capability information of the user terminal, transforming the media contents capable of accommodating in a user terminal with the codecs, and conveying the transformed media contents into the user terminal.

The present invention had been made in an effect to provide a method and an apparatus for incompatible media contents transformation based on terminal capability information dynamically transforming the media contents and conveying the transformed media contents into the user terminal, by collaborating between various contents transcoder, when the contents transformation is required between service servers providing a reproduction environment and the media contents held by the user terminal.

The present invention had been made in an effect to provide a method and an apparatus for incompatible media contents transformation based on terminal capability information in which another user terminal having the same capability information as the currently connected user terminal is connected first and receives the transformed media content service or, may provide service under transformation or pre-transformed service without a new transformation if the transformed media content service is already received.

An exemplary embodiment of the present invention provides an apparatus for incompatible media contents transformation based on terminal capability information, including: a service distributor checking the capability information of a connected user terminal and outputting transformation information a request so that the incompatible media contents selected by the user terminal are transformed into compatible media contents for the user terminal based on the capability information; and a contents transformation unit receiving the transform information, being supplied with the incompatible media contents based on the received transform information, transforming the supplied incompatible media contents into the media contents compatible with the user terminal, and providing the compatible media contents to the service distributor.

When the user terminal selects the media contents compatible with itself, the service distributor receives the selected media contents from a service server and transmits the selected media contents to the user terminal without a transformation.

The contents transformation unit includes at least two of the contents transcoder having transformation formats different from each other.

Each of the contents transcoder includes a syntax interpreter interpreting and responding to the transformation information received from the service distributor; a transformation handler invoking and managing daemons so as to transform the incompatible media contents according to a command input from the syntax interpreter; a transformation daemon transforming the incompatible media contents into the compatible media contents based on an invoke driving signal of the transformation handler; and a transmitting daemon transmitting the transformed compatible media contents to the service distributor based on the invoke driving signal of the transformation handler.

The transformation daemon includes a decoding unit in which the incompatible media contents are decoded to be transformed suitably to the user terminal; terminal capability information determining unit determining a transformation option so that the incompatible media contents are compatible with the user terminal, and an encoding unit encoding the incompatible media contents according to the transformation option.

When at least two of the user terminals having capability information different from each other are connected to the service distributor and transform the media contents, the transformation daemon drives a transformation daemon thread by the number of connected user terminals.

When at least two of the user terminals having capability information different from each other are connected to the service distributor and transform the media contents, the transmitting daemon drives a transmitting daemon thread transmitting the transformed media contents by the number of transformation daemon threads.

When the user terminals having the same capability information as each other are connected to the service distributor and transform the media contents, the contents transcoder drives one transformation daemon and one transmitting daemon.

The contents transformation unit includes a plurality of contents transcoders having codecs different from each other, and when each of the plurality of contents transcoder can not independently transform the service contents into a type suitable for the user terminal, each of the plurality of contents transcoder collaborates with each other and therefore transforms the service contents into the type suitable for the user terminal.

The service distributor is receives various service contents including the incompatible media contents from the service server.

It is also possible to connect the contents transformation unit and the service distributor via a network.

The service distributor may be simultaneously or sequentially connected with at least two heterogeneous user terminals.

An exemplary embodiment of the present invention provides a method for incompatible media contents transformation based on terminal capability information, including: checking the capability information of a connected user terminal; selecting media contents by the user terminal; transforming the selected media contents into compatible media contents for the user terminal based on the capability information when the selected media contents are incompatible with the user terminal as a result of determining the compatibility between the selected media contents and the user terminal; and transforming and transmitting the transformed media contents into a protocol capable of accommodating in the user terminal when the transformation of a transmitting protocol is necessary at the time of transmitting the compatible media contents.

The media contents transformation method includes transmitting the selected media contents to the user terminal without transforming the selected media contents when selected media contents are compatible with the user terminal, when the selected media contents are compatible with the user terminal.

In the transforming of the contents, when each of the plurality of contents transcoder having a transformation formats different from each other cannot independently transform the media contents into a type suitable for the user terminal, each of the plurality of contents transcoders collaborates with each other and therefore transforms the service contents into the type suitable for the user terminal.

In the transforming of the contents, when another user terminal having the same capability information as a currently connected user terminal is connected first, is provided with the transformed media contents, and the currently connected user terminal selects the same media contents as another user terminal, the transformed media contents are provided to the currently connected user terminal.

In the transforming of contents, when another user terminal having the same capability information as the currently connected user terminal is connected first, has been provided with the transformed media contents, and the currently connected user terminal selects the same media contents as another user terminal, the pre-transformed and stored media contents are provided.

The transforming of contents includes checking the capability information of the user terminal by a service distributor and requesting the media contents transformation information into the contents transcoder when the media contents transformation is required; and receiving the media contents transformation information by the contents transcoder and responding by using the service distributor.

The requesting includes generating a request message format so as to request the media contents transformation information, wherein the request message format includes a message format, a terminal IP, a video attribute, an audio attribute, a terminal protocol, a service server IP and a service server port.

The responding includes generating a response message format requesting the media contents transformation information, wherein the response message format includes a message format, a result value, an error value, and a transcoder IP in which the contents transformation is executed, a transcoder port in which the contents transformation is executed, a file name and a transformation ID.

According to exemplary embodiments of the present invention, a method and an apparatus for incompatible media contents transformation based on terminal capability information may check the capability information of the user terminal, may transform the media contents capable of accommodating in the user terminal with the codecs and effectively provide provide the transformed media contents to the heterogeneous terminal.

According to exemplary embodiments of the present invention, a method and an apparatus for incompatible media contents transformation based on terminal capability information may dynamically transform the media contents and may convey the transformed media contents into the user terminal, by collaborating between various contents transcoder, when the contents transformation is required between service severs providing a reproducing environment and the media contents held by the user terminal.

According to exemplary embodiments of the present invention, in the method and apparatus for incompatible media contents transformation based on terminal capability information when another user terminal having the same capability information as the currently connected user terminal is connected first, is provided with the transformed media contents or or has been provided with the transformed media contents, it is possible to provide service under transformation or pre-transformed service without the new transformation, such that additional loss is reduced by reducing the time and cost such as minimizing a duplicate transformation processing load of the contents transcoder.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration view of an entire system collaborating-transforming incompatible media contents, including an apparatus for incompatible media contents transformation based on terminal capability information according to an exemplary embodiment of the present invention.

FIG. 2 shows a configuration view of a contents transcoder for incompatible media transformation.

FIG. 3 shows a configuration view of a transformation daemon based on terminal capability information.

FIG. 4 shows collaboration-transformation and transmittance between transformation daemons for incompatible media transformation.

FIG. 5 shows a flow chart of a method for incompatible media contents transformation based on terminal capability information according to an exemplary embodiment of the present invention.

FIG. 6 shows a flow chart of checking terminal information and collaborating-transforming and transmitting contents to provide the contents service suitable for a user terminal.

FIG. 7 shows formats of transformation information, a transformation request and a transformation stop message based on terminal capability information. It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, when adding reference numerals on the components of each drawing, it should be aware that the same components have the same numerals even if you see the other drawing. In addition, in a description of the invention, if the relevant known configuration or specific details about functions can blur the gist of the present invention, the detailed description is omitted and terms described in the singular may include the concept of a multi. Also, exemplary embodiments of the present invention will be described later but the technical idea of the invention is not defined or limited to them, and is transformed variously by one skilled in the art.

The method and apparatus for exemplary embodiments of the present invention to be described below determine the capability information of the heterogeneous terminal, transform the incompatible media contents into the media contents capable of accommodating in the terminal by collaborating between the contents transcoder and then transmitting them to the terminal. Further, the method and apparatus minimizes transformation processing load of the contents transcoder so that the transformed media contents service is effectively provided to the heterogeneous terminal when various heterogeneous terminals share the same media contents.

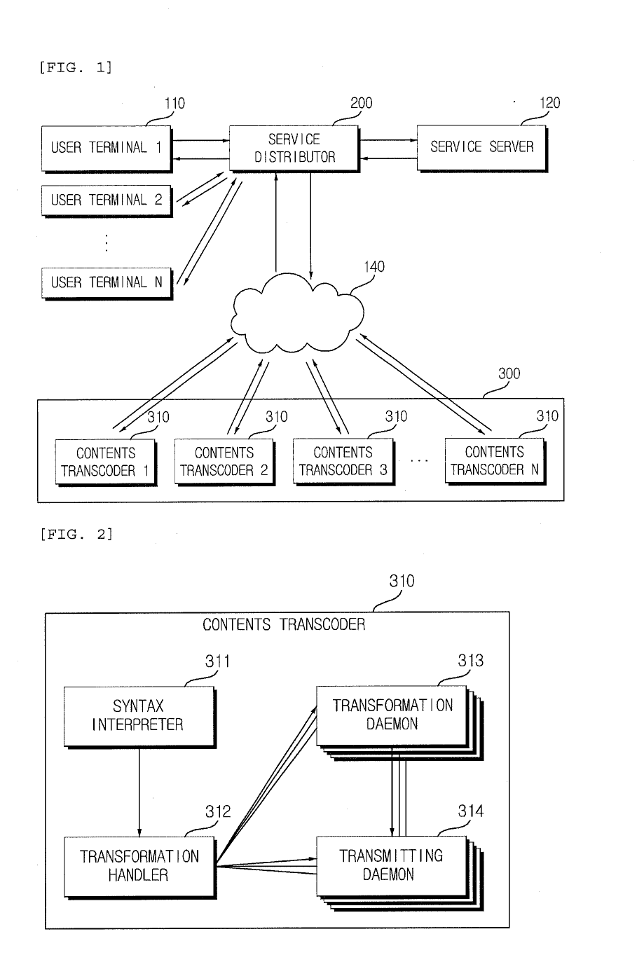

FIG. 1 is a configuration view of a system collaborating-transforming incompatible media contents based on capability information of the user terminal according to an exemplary embodiment of the present invention.

In FIG. 1, an apparatus for incompatible media contents transformation based on terminal capability information according to an exemplary embodiment of the present invention includes a service distributor 200 checking the capability information of a connected user terminal and outputting transformation information to request so that the incompatible media contents selected by the user terminal are transformed into the compatible media contents for the user terminal based on the capability information; and a contents transformation unit 300 receiving the transformation information, being supplied with the incompatible media contents based on the received transformation information, transforming the supplied incompatible media contents into the compatible media contents compatible with the user terminal, and providing the compatible media contents to the service distributor. Wherein, it is preferable that the contents transformation unit 300 includes at least two of the contents transcoders (310-1,2,3 . . . N) having the transformation formats different each other. In addition, in the present embodiment, the contents transformation unit and the service distributor are connected to each other via a network 140.

Hereinafter, an entire system configuration collaborating-transforming incompatible media contents, including an apparatus for incompatible media contents transformation will be described in detail.

As shown in FIG. 1, when the user terminal 110 configured by various heterogeneous terminal environment is connected to the service distributor 200, the service distributor 200 searches and selects lists of various media contents service and provides the media contents service suitable for the user terminal 100. The service server 120 provides media contents in various formats. The service distributor 200 requests the transformation to a plurality of contents transcoder 310 so that the incompatible media contents for the user terminal environment provided by the service server 120 are format-transformed and are transmitted suitably for the capability information of the user terminal 110 to provide the media contents service between the user terminal 110 and the service server 120. The contents transcoder 310 transforms the media contents using the codecs to transform the media contents of the service server 120 into the media contents provided by the user terminal 110. The service distributor 200 transmits the media contents to be provided to the user terminals 110. The contents transcoders 310 definitely contain the codecs that transforms the media contents according to the environment of the user terminals 110 and therefore transforms the media contents by collaborating with another contents transcoders 130-1 and 130-2 adjacent to each other when transforming into the specific codecs of the user terminals 110.

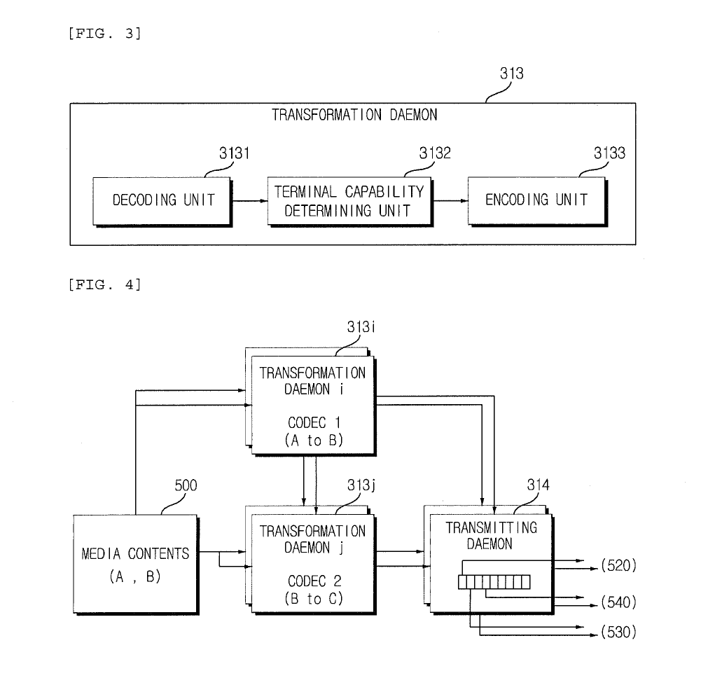

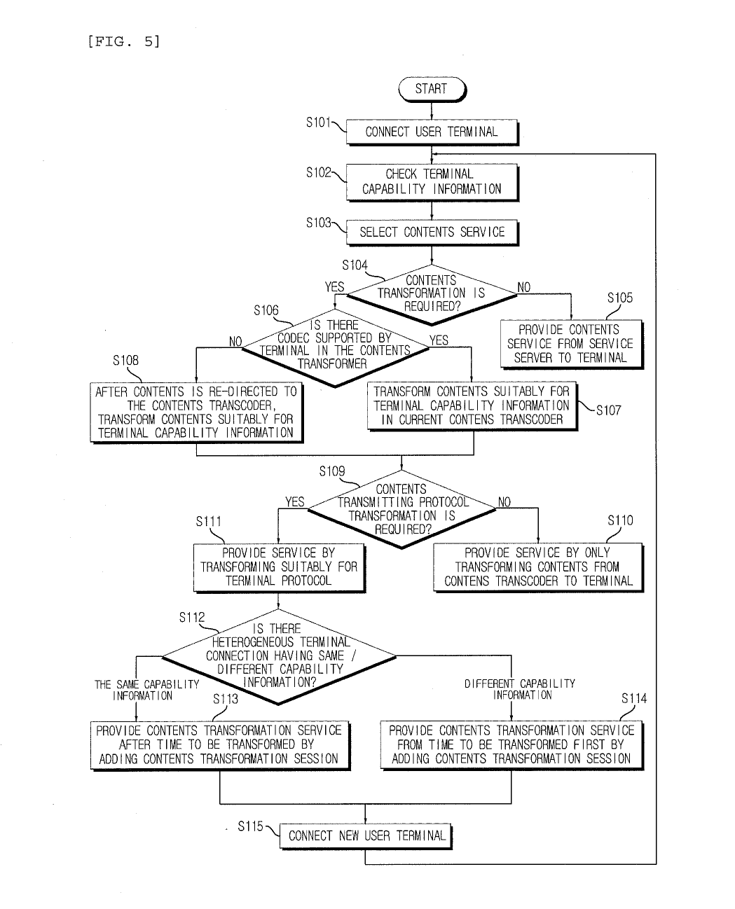

Hereinafter, the contents transcoders will be described in detail with reference to FIG. 2 and FIG. 3.

FIG. 2 shows a configuration view of contents transcoders for incompatible media transformation according to an exemplary embodiment of the present invention and FIG. 3 shows a configuration view of a transformation daemon an exemplary embodiment of the present invention. In FIG. 2, the contents transcoder 310 includes a syntax interpreter 311 interpreting and responding request for the incompatible media contents transformation option from the service distributor, a transformation handler 312 invoking and managing a transformation daemon and a transmitting daemon to transform the media contents according to a command input from the syntax interpreter, a transformation daemon 313 transforming the media contents and a transmitting daemon 314 transmitting the transformed the media contents. The transformation daemon 313 drives a transformation daemon threads by the number of connected user terminals, when the user terminal having the capability information different from each other is connected and the media contents are transformed. The transmitting daemon threads transmitting the media contents transformed by the number of transformation daemon threads are also driven. When the user terminals having the same capability information as each other is connected and the media contents are transformed, one of the transformation daemons is only driven and one of transformation daemons is also only driven to minimize a load so as to be driven at the time of transforming.

In FIG. 3, the transformation daemon 313 includes a decoding unit 3131, a terminal capability information determining unit 3132 and an encoding unit 3133, and is invoked and driven by the transformation handler 312. The decoding unit 3131 decodes the media contents received from a service server 120 to suitably transform for the user terminal capability information, the terminal capability information determining unit 3132 determines a transformation option so that the incompatible media contents are compatible with the user terminal and the encoding unit 3133 determines an option suitable for the terminal capability information to transform the media contents with the determined values.

FIG. 4 shows collaboration-transformation and transmittance between transformation daemons for incompatible media transformation.

In FIG. 4, media contents 500 received from the service server 120 are contents encoded with a codecs A, if the transformation daemon i(313i) has codecs A to B and the transformation daemon j(313j) has codecs B to C, when a codecs belonging to the capability information of the user terminal is a codecs C, the media contents are transmitted and transformed into the transformation daemon i and the transformed media contents are transmitted and re-transformed into the transformation daemon j. If the media contents 500 received from the service server 120 are encoded with codecs B, the media contents are directly transmitted to the transformation daemon j(313j) to achieve the media contents transformation. The transformed media contents are transmitted to the transmitting daemon 314 ,stacked at a first queue 520 and then transmitted to the user terminal 110.

Hereinafter, when another user terminal having the same capability information is connected and receives the transformed media contents, the transformed media contents are conveyed into the user terminal from a stack portion at the transformed second queue 530. Since the same transmitting daemon is used, the transformation and transmitting load of the media contents can be minimized.

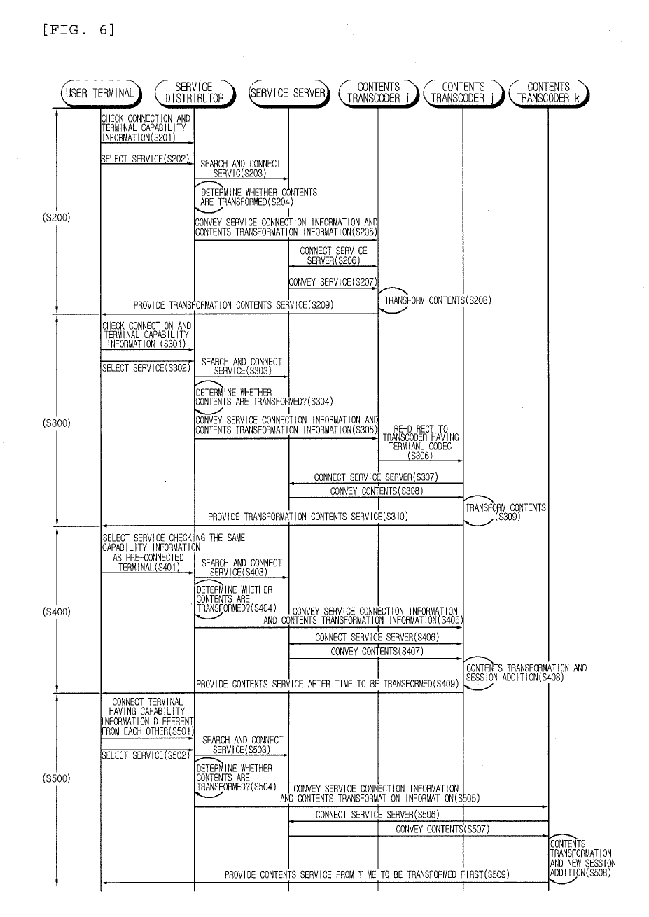

FIG. 5 shows a flow chart for minimizing the transformation load depending on the media contents transformation and the terminal type based on terminal capability information between the heterogeneous terminals according to an exemplary embodiment of the present invention.

Referring to FIG. 5, when the user terminals 110 are connected, the orders of determining whether or not the media contents are transformed, searching the media contents transcoder, transforming the media contents, selecting communication protocol transmitting the media contents and determining the transformation time when the heterogeneous terminals are connected are provided to minimize the transformation load.

When a user terminal 110 is connected (S101), the service distributor 200 checks the terminal capability information (S102). The connected user terminal 110 searches a contents service list in the service distributor 200 to select a desired service (S103). The service distributor 200 checks whether the selected service can be validly provided to the connected user terminal without transforming the contents (S104), when not necessitating the transformation, the selected contents of the service list are transmitted from the service server 120 to the user terminal without transforming the contents (S105). When necessitating the transformation suitable for the user terminal capability, the contents transcoder 310 transforms the media contents with the codecs belonging to the user terminal (S106 to S108).

For example, when describing in detail, the media contents provided by the service server 120 are encoded with MPEG4, and the contents transcoder should transform the media contents as MPEG4 and H.264 when the user terminal owns H.264 codecs (S107). However, when the contents transcoder 1 (310) has the codecs transformed with MPEG4 and H.263 and the contents transcoder 2 (310) has the codecs transformed with H.263 and H.264, the contents transcoder 1 (310) hands over the transformed result to an input of the contents transcoder 2 (310) and should collaborate so as to perform transformation operations. That is, when there are no codecss supported by the terminal in the contents transcoder receiving the media contents, the media contents are re-directed to the contents transcoder having codecs supported by terminal (S108). The redirected media contents are transformed into the contents suitable for the terminal capability information (S108). The transformed media contents are transmitted to terminal protocols that can be accommodated in the user terminal.

When another user terminal having the same capability information as a currently connected user terminal is connected first (S112) and is provided with the transformed media contents service, and the currently connected user terminal selects the same media contents as another user terminal, the media contents service is provided after the pre-transformed time (S113). Further, when another user terminal having the same capability information as the currently connected user terminal is connected first (S112), and has received the transformed media contents service is already received, the currently connected user terminal is provided with the previous transformed and stored media contents.

Therefore, a load of the contents transcoder can be minimized by reducing the transformation operations of the same media contents requesting the transformation However, when a user terminal having capability information different from each other is connected and the same service is selected, the user terminal is provided with the media contents service by a process transforming the media contents from the beginning (S114). when a new user terminal is connected (S115), the terminal capability information is checked.

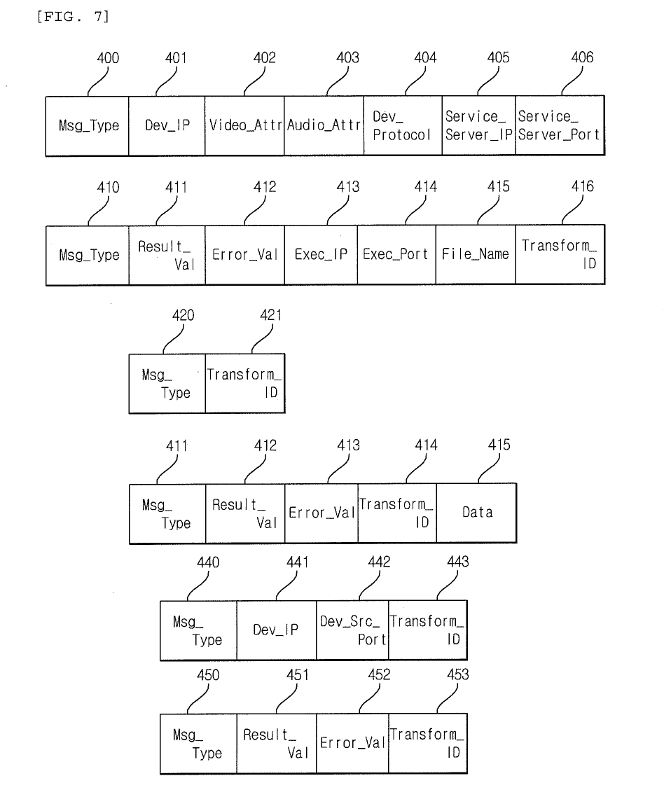

FIG. 6 is a flow chart showing operations checking the capability information of the terminal and collaborating-transforming and transmitting the contents to provide the contents service suitable for the user terminal among the user terminal, the service distributor, the service server and the contents transcoders.

When the user terminal is connected to the service distributor, the service distributor checks the capability information of the user terminal (S201). The user terminal selects a desired service of the service items presented by the contents service list (S202). The service distributor searches the service items selected by the user terminal and is connected to the service server providing the selected service (S203). The service distributor compares the capability information of the user terminal with the service capability provided by the service server and determines whether or not the media contents is transformed (S204).

The service distributor conveys the contents transformation information to be suitably transformed according to connection information and the capability information of the user terminal to the contents transcoder when the contents transformation is necessary (S205). The contents transcoder is connected to the service server via the service distributor (S206) to receive the media contents (S207) and transforms the received media contents into the media contents suitable for the user terminal based on the contents transformation information (S208). The user terminal is connected to the content transcoder and is provided with the required service by receiving the transformed media contents (S209).

For example, when describing in detail, the user terminal includes a decoder C and the media contents provided by the service server is encoded with codecs A. When a contents transcoder j supports codecs A to B and a contents transcoder j supports codecs B to C, the service distributor conveys service connection information and the media content transformation information to the contents transcoder I (S305) and the contents transcoder j again re-directs the transformation information to the contents transcoder j (S306). The content transcoder j is connected to the service server (S307) to receive the media contents (S308) and transforms the media contents suitably for the capability of the user terminal (S309) to convey the transformed media contents to the user terminal (S310).

When a user terminal having the same capability information is connected, the user terminal receives the transformed media contents (S409) by additionally connecting only a service session (S408) in a session in which the existing media contents are being transformed, such that a load of the media contents transformation can be minimized.

When the capability information of a currently connected user terminal is different from the capability information of the existing connected user terminal, a new media contents transformation thread should be added (S508) and the transformed media contents are provided to the currently connected user terminal (S509).

FIG. 7 shows formats of transformation information, a transformation requesting and a transformation stop message based on terminal capability information according to an exemplary embodiment of the present invention.

Referring to FIG. 7, the service distributor 200 checks the capability information of the user terminal, and requests the media contents transformation information to the contents transcoder when the media contents transformation is required.

Request message formats requesting the media contents transformation information includes include a message format 400, a terminal IP 401, a video attribute 402, an audio attribute 403, a terminal protocol 404, a service server IP 405 and a service server port 406.

The message format 400 represents a type of message for the request and the response. The terminal IP 401 represents an IP belonging to the user terminal. The video attribute 402 represents attribute information such as a file format, a video codecs, a video bit rate, a frame rate and a resolution of an attribute related to a video of the media contents to be transformed. The audio attribute 403 represents attribute information such as an audio codecs, an audio sample rate, an audio bit rate and an audio channel of an attribute related to an audio of the media contents to be transformed. The terminal protocol 404 represents the service protocol requested and provided by the terminal. The service server IP 405 represents the IP of the server providing the media contents service selected by the user terminal. The service server port 406 represents a port of the server providing the media contents service selected by the user terminal.

The contents transcoder 310 receives the media contents transformation information and responses to the service distributor 200.

A response message format responding to the request the media contents transformation information includes a message format 410, a result value 411, an error value 412, a transcoder IP 413, in which the contents transformation is executed, a transcoder port 414 in which the contents transformation is executed, a file name 415 and a transformation ID 416.

The message format 410 represents a type of message for the request and the response. The result value 411 represents whether the processing for the request is performed well. When an error is caused, the error value 412 represents the type of error. The transcoder IP 413 in which the contents transformation is executed represents the transcoder IP in which the media contents transformation is executed. The transcoder port 414 in which the contents transformation is executed represents the transcoder port in which the media contents transformation is executed. The file name 415 represents the file name of the transcoder to connect the user terminal to the contents transcoder. A transformation ID 416 is a process ID of the transcoder to connect the user terminal to the contents transcoder.

The service distributor 200 requests to the contents transcoder 310 in order to transform the media contents data, after the media contents transformation information are transmitted and received.

A message format requesting the media contents transformation includes a message format 420 and transformation ID 421. The message format 420 represents a type of message for the request and the response. The transformation ID 421 is a process ID of the transcoder to connect the user terminal to the contents transcoder.

After the media contents data transformation is requested, a response message includes a message format 430, a result value 431, an error value 432, a transformation ID 433 and a data 434. The message format 430 represents a type of message for the request and the response. The result value 431 represents whether the processing for the request is performed well. When an error is caused, the error value 432 represents the type of error. A transformation ID 433 is a process ID of the transcoder to connect the user terminal to the contents transcoder. The data 434 is a data in which the media contents transformation is performed.

After the media contents transformation is completed, when the transformation stop is required, the service distributor 200 requests the transformation stop to the contents transcoder 310.

A message format requesting the media contents transformation stop includes a message format 440, a terminal IP 441, a terminal source port 442, and a transformation ID 443. The message format 440 represents a type of message for the request and the response. The terminal IP 441 represents the IP belonging to the user terminal. The terminal source port 442 represents a port belonging to the user terminal. The transformation ID 443 is a process ID of the transcoder to connect the user terminal to the media contents transcoder.

After the media contents data transformation stop is requested, a response message includes a message format 450, a result value 451, an error value 452 and a transformation ID 453. The message format 450 represents a type of message for the request and the response. The result value 451 represents whether the processing for the requesting is performed well. When an error is caused, the error value 452 represents the type of error. A transformation ID 453 is a process ID of the transcoder to connect the user terminal to the media contents transcoder.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for incompatible media contents transformation based on terminal capability information, comprising;
a service distributor checking the capability information of a connected user terminal and outputting transformation information to request so that the incompatible media contents selected by the user terminal are transformed into compatible media contents for the user terminal based on the capability information; and
a contents transformation unit receiving the transform information, being supplied with the incompatible media contents based on the received transform information, transforming the supplied incompatible media contents into the media contents compatible with the user terminal, and providing the compatible media contents to the service distributor.

2. The apparatus of claim 1, wherein, when the user terminal selects the media contents compatible with itself, the service distributor receives the selected media contents from a service server and transmits the selected media contents to the user terminal without a transformation.

3. The apparatus of claim 1, wherein the contents transformation unit includes at least two of the contents transcoders having transformation formats different from each other.

4. The apparatus of claim 3, wherein each of the contents transcoders includes
a syntax interpreter interpreting and responding to the transformation information received from the service distributor;
a transformation handler invoking and managing daemons so as to transform the incompatible media contents according to a command input from the syntax interpreter;
a transformation daemon transforming the incompatible media contents into the compatible media contents based on an invoke driving signal of the transformation handler; and
a transmitting daemon transmitting the transformed compatible media contents to the service distributor based on the invoke driving signal of the transformation handler.

5. The apparatus of claim 4, wherein the transformation daemon includes
a decoding unit in which the incompatible media contents are decoded to be transformed suitably to the user terminal;
a terminal capability information determining unit determining a transformation option so that the incompatible media contents are compatible with the user terminal; and
an encoding unit encoding the incompatible media contents according to the transformation option.

6. The apparatus of claim 4, wherein when at least two of the user terminals having the capability information different from each other are connected to the service distributor and transform the media contents, the transformation daemon drives a transformation daemon threads by the number of connected user terminals.

7. The apparatus of claim 6, wherein the transmitting daemon drives a transmitting daemon threads transmitting the transformed media contents by the number of transformation daemon threads.

8. The apparatus of claim 4, wherein when the user terminals having the same capability information different from each other are connected to the service distributor and transform the media contents, the contents transcoder drives one transformation daemon and one transmitting daemon.

9. The apparatus of claim 1, wherein the contents transformation unit includes a plurality of contents transcoders having codecs different from each other, and when each of the plurality of contents transcoders do not independently transform the service contents into a type suitable for the user terminal, each of the plurality of contents transcoders collaborates with each other and therefore transforms the service contents into the type suitable for the user terminals.

10. The apparatus of claim 1, wherein the service distributor is receives various service contents including the incompatible media contents from the service server.

11. The apparatus of claim 1, wherein the contents transformation unit and the service distributor are connected via a network.

12. The apparatus of claim 1, wherein the service distributor is simultaneously or sequentially connected with at least two heterogeneous user terminals.

13. An method for incompatible media contents transformation based on terminal capability information, comprising;
checking capability information of a connected user terminal;
selecting media contents by the user terminal;
transforming the selected media contents into the compatible media contents for the user terminal based on the capability information when the selected media contents are incompatible with the user terminal as a result of determining the compatibility between the selected media contents and the user terminal; and
transforming and transmitting the transformed media contents to a protocol capable of accommodating in the user terminal when the transformation of a transmitting protocol is necessary at the time of transmitting the compatible media contents.

14. The method of claim 13, further comprising, transmitting selected media contents to the user terminal without transforming the selected media contents when the selected media contents are compatible with the user terminal, when the selected media contents are compatible with the user terminal.

15. The method of claim 13, wherein, in the transforming of the contents, when each of the plurality of contents transcoders having a transformation formats different from each other does not independently transform the media contents into a type suitable for the user terminal, each of the plurality of contents transcoders collaborates with each other and therefore transforms the service contents into the type suitable for the user terminals.

16. The method of claim 13, wherein, in the transforming of the contents, when another user terminal having the same capability information as a currently connected user terminal is connected first, is provided with the transformed media contents, and the currently connected user terminal selects the same media contents as another user terminal, the transformed media contents are provided to the currently connected user terminal.

17. The method of claim 13, wherein, in the transforming of contents, when another user terminal having the same capability information as the currently connected user terminal is connected first, has been provided with the transformed media contents, and the currently connected user terminal selects the same media contents as another user terminal, the pre-transformed and stored media contents are provided to the currently connected user terminal.

18. The method of claim 13, wherein, the transforming of contents includes
checking the capability information of the user terminal by a service distributor and requesting the media contents transformation information into the contents transcoder when the media contents transformation is required; and
receiving the media contents transformation information by the contents transcoder and responding by the service distributor.

19. The method of claim 18, the requesting includes generating a request message format so as to request the media contents transformation information,
wherein the request message format include a message format, a terminal IP, a video attribute, an audio attribute, a terminal protocol, a service server IP and a service server port.

20. The method of claim 18, the responding includes generating a response message format responding to the requesting of the media contents transformation information,
wherein the response message format includes a message format, a result value, an error value, a transcoder IP in which the contents transformation is executed, a transcoder port in which the contents transformation is executed, a file name, and a transformation ID.
